(19) United States
(12) Patent Application Publication
(10) Pub. No.: US 2022/0330586 A1
(43) Pub. Date: Oct. 20, 2022

(54) RAW CHINESE NOODLES, METHOD FOR PRODUCING THE SAME, AND METHOD FOR PREVENTING DISCOLORATION OF RAW CHINESE NOODLES

(71) Applicant: NISSIN FOODS HOLDINGS CO., LTD., Osaka-shi, Osaka (JP)

(72) Inventor: Naoto Ito, Osaka (JP)

(21) Appl. No.: 17/762,653

(22) PCT Filed: Mar. 12, 2021
(86) PCT No.: PCT/JP2021/010014

§ 371 Date: Mar. 22, 2022

(30) Foreign Application Priority Data
Mar. 28, 2020 (JP) 2020-059229
Feb. 5, 2021 (JP) 2021-017162

(51) Int. Cl. A23L 7/109; A23L 29/00

(52) U.S. Cl. CPC A23L 7/109; A23L 29/015

(57) ABSTRACT

The present invention addresses the problem of providing raw Chinese noodles whose discoloration and texture deterioration in the long-term storage have been suppressed. The problem is solved by raw Chinese noodles in which a main raw material powder contains calcium monohydrogen phosphate hydrate, The raw Chinese noodles can be produced by adding kneading water containing kansui dissolved therein to a powder obtained by adding calcium monohydrogen phosphate hydrate to a main raw material powder and subjecting them to powder mixing, kneading the resulting mixture with a mixer to prepare noodle dough, and then carrying out noodle making. The content of the calcium monohydrogen phosphate hydrate or the amount thereof added is preferably 0.15 to 2.5% by weight based on the main raw material powder.

### TECHNICAL FIELD

The present invention relates to raw Chinese noodles, a method for producing the same, and a method for preventing discoloration of raw Chinese noodles.

A large number of raw Chinese noodles obtained by kneading a main raw material powder such as wheat flour with kneading water containing kansui to prepare noodle dough and making noodles from the dough have been conventionally on the market. Such noodles include noodles that are immediately consumed in ramen noodles shops and the like, chilled raw Chinese noodles having a best-before period of about one month at a chilled temperature range of no more than 10° C., and raw Chinese noodles for souvenirs having a best-before period of about one month at ordinary temperature because of low water content.

Among these, the chilled raw Chinese noodles and the raw Chinese noodles for souvenirs have problems that as the storage term becomes longer, the noodles change to brownish in color, and the texture becomes a hard and brittle texture of hard surface and non-chewy core.

As a prior art technical literature for the purpose of preventing discoloration of noodles, Patent Literature 1 or 2. is known. In Patent Literature 1, formulation of a yellow pigment for coloring Chinese noodles, which is formulated by mixing kansui and one or two calcined shell calcium with rutin and a specific water-soluble antioxidant, is described as a method for inexpensively obtaining a vivid yellow color of Chinese noodles while continuously showing little discoloration.

In Patent Literature 2, a quality improving agent for processed food products using wheat flour as a raw material, the quality improving agent containing one or two or more acid components selected from phosphoric acid, acetic acid, fumaric acid, malic acid, succinic acid, citric acid, tartaric acid, lactic acid, adipic acid, and salts thereof, and a fading suppression component, is described as a technique to maintain color tone of processed food products using wheat flour as a raw material during the production, that is, a technique to efficiently prevent fading of yellowish color over time to thereby retain quality.

However, discoloration or texture deterioration of raw Chinese noodles that are stored for a long time in a chilled state or at ordinary temperature cannot be sufficiently suppressed even by these techniques.

As techniques in which a calcium salt is used for noodles, techniques of Patent Literatures 3 to 5 are known. In Patent Literature 3, Chinese noodles of Patent Literature 3 comprising water containing calcium phosphate and having pH of 10 or more in an amount of 25 to 50% by weight based on wheat flour is described as Chinese noodles containing no kansui.

In Patent Literature 4, there is described, as a technique to provide noodles having been further improved in unique stickiness of strong “chewy texture” and toughness inherent in raw Chinese noodles and also having long-term storability, a method for producing three-layer raw noodles, comprising the following steps, that is, steps of (1) kneading a raw material powder containing wheat flour or wheat flour and starch as main components with water after adding an alkaline agent, salt, etc. as needed, thereby preparing noodle dough for an outer layer, (2) kneading a raw material powder containing wheat flour or wheat flour and starch as main components with alginic acid and/or an alginate, an alkaline agent and water after adding salt, etc. as needed, thereby preparing noodle dough for an inner layer having neutral to weakly alkaline pH, (3) subjecting the dough for an inner layer and the dough for an outer layer to an ordinary method such as a rolling method to prepare noodle belts, then further subjecting them to compounding rolling out to prepare a noodle belt composed of outer layer/inner layer/outer layer, and subjecting the noodle belt to an ordinary method to prepare noodle strings, (4) subjecting the noodle strings to acid solution treatment simultaneously with gelatinization treatment or after gelatinization treatment to adjust the pH of the noodle strings to an acid region, and (5) seal-packaging the acid-treated noodle strings, and then subjecting them to heat sterilization treatment, wherein calcium and/or a calcium salt is added. in the kneading for preparing the noodle dough for an inner layer.

In Patent Literature 5, a food additive composed of inorganic grains having a specific average primary grain diameter, aggregation properties, sharpness, various viscosities, thixotropic properties, BET specific surface area and water absorption properties is described as a food additive for giving various food compositions, such as mineral component-enriched instant noodles, chewing gum, biscuits, pancake premix, processed cheese and fish paste products, without destroying the texture.

These literatures only describe that a calcium salt is used instead of kansui, or it is used for preparing a calcium alginate gel by allowing it to react with alginic acid, or it is used for nutrient enhancement.

### CITATION LIST

### Patent Literature

Patent Literature 1: Japanese Patent Laid-Open No. 10-108646

Patent Literature 2: Japanese Patent Laid-Open No. 2012-10658

Patent Literature 3: Japanese Patent Laid-Open No. 8-280344

Patent Literature 4: Japanese Patent Laid-Open No. 6-209731

Patent Literature 5: Japanese Patent Laid-Open No. 2002-369666

### SUMMARY OF INVENTION

### Technical Problem

It is an object of the present invention to provide raw Chinese noodles whose discoloration and texture deterioration in the long-term storage have been suppressed.

### Solution to Problem

The present inventors have earnestly studied a method for suppressing discoloration and texture deterioration of chilled raw Chinese noodles or raw Chinese noodles for souvenirs in the long-term storage, and as a result, they have coincidentally found the present invention and accomplished the present invention.

That is to say, the present invention refers to raw Chinese noodles comprising calcium monohydrogen phosphate hydrate.

In the raw Chinese noodles according to the present invention, a content of the calcium monohydrogen phosphate hydrate is preferably 0.15 to 2.5% by weight based on the weight of a main raw material powder.

A method for producing raw Chinese noodles according to the present invention preferably comprises adding kneading water containing kansui dissolved therein to a powder obtained by adding calcium monohydrogen phosphate hydrate to a main raw material powder and subjecting them to powder mixing, kneading the resulting mixture with a mixer to prepare noodle dough, and then carrying out noodle making.

In the method for producing raw Chinese noodles according to the present invention, the calcium monohydrogen phosphate is preferably added in an amount of 0.15 to 2.5% by weight based on the weight of the main raw material powder.

By adding calcium monohydrogen phosphate hydrate to noodles, discoloration of raw Chinese noodles in the long-term storage can be suppressed.

### ADVANTAGEOUS EFFECT OF INVENTION

By the present invention, raw Chinese noodles whose discoloration and texture deterioration in the long-term storage have been suppressed can be provided.

### DESCRIPTION OF EMBODIMENT

Hereinafter, the present invention will be described in detail. However, the present invention is not limited to the following description. The raw Chinese noodles according to the present invention refer to raw Chinese noodles which have been subjected to no heating process such as steaming or boiling and which are stored at a chilled temperature range or an ordinary temperature.

### 1. Noodle Raw Material Formulation

For the raw Chinese noodles according to the present invention, a raw material for usual Chinese noodles can be used. That is to say, examples of main raw material powders include wheat flour, and various starches, such as potato starch, tapioca starch, wheat starch and corn starch, and these may be used singly or may be used by mixing them. As the starches, raw starch, gelatinized starch, and modified starches, such as acetylated starch, etherified starch and crosslinked starch, can also be used.

In the present invention, to these main raw material powders, salt, an alkaline agent such as kansui, various thickening agents, gluten, egg white, a noodle quality modifier, edible fat or oil, various pigments such as a carotene pigment, a preservative, etc. that are generally used in the production of Chinese noodles can be added. These may be added as powders together with the main raw material powder or may be added by dissolving or suspending them in kneading water. As kansui among these, a carbonate such as sodium carbonate or potassium carbonate is preferably used in order to impart a unique flavor of Chinese noodles and in order to produce a chewy texture, and it is preferably added in an amount of 1 to 2% by weight based on the main raw material powder. In order to increase pH of the noodles to thereby improve storability, an alkaline agent such as calcined calcium can be added in addition to kansui.

In the present invention, calcium monohydrogen phosphate hydrate is added. Since the calcium monohydrogen phosphate hydrate hardly dissolves in water, it is preferably added by subjecting it, to powder mixing together with the main raw material powder. As calcium monohydrogen phosphate, an anhydride and a hydrate (dihydrate) are present, but the anhydride has no suppression effect on the deterioration over time such as discoloration or texture change, and only the hydrate has a suppression effect thereon, though the cause is unknown. As a result of studies of various calcium salts, some of them have an effect of suppressing discoloration over time, but, they affect the texture or the flavor such as kansui odor, and texture deterioration over time cannot be suppressed, while calcium monohydrogen phosphate hydrate less affects the texture or the flavor and is most effective for suppressing discoloration and texture deterioration over time.

The amount of the calcium monohydrogen phosphate hydrate added is preferably 0.15 to 2.5% by weight based on the main raw material powder. in the case of chilled raw Chinese noodles, the noodles are stored at 10° C. or lower, so that the degree of browning is lower than that of raw Chinese noodles stored at ordinary temperature, and the effect of suppressing discoloration and texture deterioration over time can be confirmed when the amount added is 0.15% by weight or more based on the main raw material powder. In the case of raw Chinese noodles for souvenirs stored at ordinary temperature, the degree of browning is high, and the effect of suppressing discoloration and texture deterioration over time can be confirmed when the amount added is 1% by weight or more based on the main raw material powder. However, an amount added of more than 2.5% by weight based on the main raw material powder affects the texture of noodles.

### 2. Kneading Step

Preparation of noodle dough (dough) according to the present invention may be carried out in accordance with an ordinary method. That is to say, the main raw material powder, a powder containing calcium monohydrogen phosphate hydrate, and kneading water in which sodium carbonate and/or potassium carbonate are dissolved may be kneaded with a batch mixer, a flow jet mixer, a vacuum mixer or the like in such a manner that they are homogeneously mixed, and crumbly dough may be prepared.

### 3. Noodle Making Step

Subsequently, from the dough prepared, noodle strings are prepared. Preparation thereof may be carried out in accordance with an ordinary method, and examples of the methods include a method in which the dough is extruded using an extruder or the like to prepare noodle strings, and a method in which a crude noodle belt is prepared from the dough using rolls, then it is subjected to compounding or the like to prepare a noodle belt, the noodle belt is further rolled out a plurality of times using rolls to give a prescribed noodle belt thickness, and then the noodle belt is cut out with a cutting-out roll called a cutting blade, thereby preparing noodle strings. When noodle strings are prepared after a noodle belt is prepared, rolling out and cutting out may be carried out after the noodle belt is prepared using an extruder, or rolling out and cutting out may be carried out after a noodle belt having a multilayer structure is prepared by uniting a plurality of noodle belts together. When an extruded noodle belt or extruded noodle strings are prepared using an extruder or the like, this preparation is preferably carried out under reduced pressure.

### 4. Others

On the raw noodles prepared, flour is sprinkled, or the surfaces of the noodles are dried, when needed, thereafter the noodles are enclosed in a bag of polyethylene, polypropylene or the like, and thus, raw Chinese needles stored at a chilled temperature range or an ordinary temperature can be prepared. The raw noodles enclosed in a bag are introduced in a bag or a box together with soup and ingredients, and can be sold at stores.

Hereinafter, the present embodiment will be described in more detail with reference to Examples.

### EXAMPLES

### <EXPERIMENT 1>STUDIES WITH ORDINARY TEMPERATURE-STORABLE RAW CHINESE NOODLES

### Example 1

With 1 kg of a main raw material powder composed of 1000 g of all-purpose flour, 10 g of an egg white powder, 5 g of gluten, 1.5 g of calcined calcium, and 10 g of calcium monohydrogen phosphate hydrate were powder mixed, to the resulting mixture was added kneading water in which 10 g of salt, 12 g of kansui formulation (sodium carbonate 6:potassium carbonate 4), 50 g of 70% alcohol formulation, 15 g of 60% sodium lactate, 5 g of trehalose, and 1 g of a gardenia pigment were dissolved in 280 g of water, and they were kneaded with a normal pressure mixer for 15 minutes, thereby preparing dough.

The dough prepared was compounded to prepare a noodle belt, the noodle belt was aged for 20 minutes, then the noodle belt was rolled out to 1.5 mm by a rolling method, and the resulting noodle belt was cut with a No. 16 square roll cutting blade, thereby preparing noodle strings.

Subsequently, on 110 g of one serving of the noodle strings prepared, 4 g of flour composed of oxidized starch of sago starch was sprinkled, and the noodle strings were sealed in a polyethylene bag, thereby preparing a raw Chinese noodles sample.

### Example 2

A raw Chinese noodles sample was prepared in accordance with the method of Example 1, except that the amount of the calcium monohydrogen phosphate hydrate added was changed to 15 g.

### Example 3

A raw Chinese noodles sample was prepared in accordance with the method of Example 1, except that the amount of the calcium monohydrogen phosphate hydrate added. was changed to 20 g.

### Example 4

A raw Chinese noodles sample was prepared in accordance with the method of Example 1, except that the amount of the calcium monohydrogen phosphate hydrate added. was changed to 25 g.

### Comparative Example 1

A raw Chinese noodles sample was prepared in accordance with the method of Example 1, except that the amount of the calcium monohydrogen phosphate hydrate was not added.

### Comparative Example 2

A raw Chinese noodles sample was prepared in accordance with the method of Example 2, except that tricalcium phosphate was used instead of the calcium monohydrogen phosphate hydrate.

### Comparative Example 3

A raw Chinese noodles sample was prepared in accordance with the method of Example 2, except that anhydrous calcium monohydrogen phosphate was used instead of the calcium monohydrogen phosphate hydrate.

The raw Chinese noodles prepared in each experimental plot of Experiment 1 were allowed to stand at 40° C. for 7 days and thereby subjected to forced deterioration, and they were evaluated by 5 veteran panelists.

Color change in each experimental plot was evaluated. Regarding the color, a difference in color between the samples before and after forced deterioration was visually confirmed to carry out evaluation of the discoloration suppression effect, and in addition, the a-value was measured by a colorimeter (manufactured by KONICA MINOLTA, INC., model number CR 401), then a difference between before and after deterioration was measured, and whether the discoloration was suppressed as a numerical value was confirmed. The discoloration suppression evaluation by visual observation was carried out by using the samples of Comparative Example 1 before and after forced deterioration as references. When a sample that was equivalent to Comparative Example 1 before forced deterioration was evaluated as 5, and when Comparative Example 1 after forced deterioration was evaluated as 1, a sample that was slightly inferior to Comparative Example 1 before forced deterioration but was generally good was evaluated as 4, a sample that was inferior to Comparative Example 1 before forced deterioration but was generally acceptable was evaluated as 3, a sample that was better than Comparative Example 1 after forced deterioration but was bad was evaluated as 2, and a sample that was equivalent to Comparative Example 1 after forced deterioration and was bad was evaluated as 1.

Regarding sensory evaluation of the test sample, each raw Chinese noodles sample was placed in 1500 ml of boiling water, boiled for 3 minutes, subjected to draining of hot water, and then eaten with soy sauce ramen soup previously prepared, and the evaluation was carried out.

Sensory evaluation of kansui odor was carried out using samples before forced deterioration, and Comparative Example 1 before forced deterioration was used as a reference. A sample that was equivalent to Comparative Example 1 was evaluated as 5, a sample that was inferior to Comparative Example 1 but had kansui odor and was generally good was evaluated as 4, a sample that was inferior to Comparative Example 1 but had kansui odor and was generally acceptable was evaluated as 3, a sample that was inferior to Comparative Example 1 but slightly had kansui odor though the odor was weak was evaluated as 2, and a sample that hardly had kansui odor was evaluated as 1. Regarding the kansui odor, there was almost no difference due to forced deterioration.

Sensory evaluation of a texture was carried out, and the samples of Comparative Example 1 before and after forced deterioration were used as references. When a sample that was equivalent to Comparative example 1 before forced deterioration was evaluated as 5, and when Comparative Example 1 after forced deterioration was evaluated as 1, a sample that was slightly inferior to Comparative Example 1 before forced deterioration but was generally good was evaluated as 4, a sample that was inferior to Comparative Example 1 before forced deterioration but was generally acceptable was evaluated as 3, a sample that was better than Comparative Example 1 after forced deterioration but was bad was evaluated as 2, and a. sample that was equivalent to Comparative Example 1 after forced deterioration and was bad was evaluated as 1.

Evaluation results of Experiment 1 are set forth in the following Table 1.

TABLE 1

| | | Amount added | Flavor | Texture | Texture | Color | | | |
|---|---|---|---|---|---|---|---|---|---|
| Experi- | | (g/kg of main | before | before | After | Before | After | | |
| mental | | raw material | deterio- | deterio- | deterio- | Deterio- | deterio- | Eval- | |
| plot | Calcium salt | powder) | ration | ration | ration | ration a* | ration a* | uation | Comment |
| Exam- ple | Calcium monohydrogen | 10 | 5 | 5 | 3 | −4.93 | −2.91 | 3 | Kansui odor before forced deterioration is almost equivalent to that of |
| 1 | phosphate (dihydrate) | | | | | | | | Comparative Example 1. Texture before forced deterioration is also |
| | | | | | | | | | almost equivalent to that of Comparative Example 1. Texture after |
| | | | | | | | | | forced deterioration is generally acceptable because surface hardness is |
| | | | | | | | | | removed as compared with Comparative Example 1 after forced |
| | | | | | | | | | deterioration and core is sticky. Discoloration after forced |
| | | | | | | | | | deterioration is suppressed as compared with Comparative Example 1 |
| | | | | | | | | | and is generally acceptable. |
| Exam- ple | Calcium monohydrogen | 15 | 4 | 5 | 4 | −4.98 | −4.10 | 4 | Kansui odor before forced deterioration is inferior to that of |
| 2 | phosphate (dihydrate) | | | | | | | | Comparative Example 1 but is generally good. Texture before forced |
| | | | | | | | | | deterioration is also almost equivlaent to that of Comparative Example |
| | | | | | | | | | 1. Texture after forced deterioration is generally good because |
| | | | | | | | | | surface hardness is removed as compared with Example 1 and core is |
| | | | | | | | | | sticky. Discoloration after forced deterioration is obviously |
| | | | | | | | | | suppressed as compared with Comparative Example 1 and is generally |
| | | | | | | | | | good. |
| Exam- ple | Calcium monohydrogen | 20 | 4 | 4 | 4 | −4.95 | −4.40 | 4 | Kansui odor before forced deterioration is inferior to that of |
| 3 | phosphate (dihydrate) | | | | | | | | Comparative Example 1 but is generally good. Texture before forced |
| | | | | | | | | | deterioration is softer and inferior to that of Comparative Example 1 |
| | | | | | | | | | but is generally good. Texture after forced deterioration is slightly |
| | | | | | | | | | softer that that of Example 2 but is generally good. Discoloration |
| | | | | | | | | | after forced deterioration is obviously suppressed as compared with |
| | | | | | | | | | Comparative Example 1 and is |
| | | | | | | | | | generally good. |
| Exam- ple | Calcium monohydrogen | 25 | 3 | 4 | 3 | −4.90 | −4.56 | 4 | Kansui odor before deterioration is inferior to that of |
| 4 | phosphate (dihydrate) | | | | | | | | Comparative Example 1 but is generally acceptable. Texture before |
| | | | | | | | | | forced deterioration is softer and inferior to that of Comparative |
| | | | | | | | | | Example 1 but is generally good. Texture after forced deterioration is |
| | | | | | | | | | slightly softer than that of Example 3 but is generally acceptable. |
| | | | | | | | | | Discoloration after forced deterioration is obviously suppressed as |
| | | | | | | | | | compared with comparative Example 1 and is generally good. |
| Com- parative | None | 0 | 5 Refer- | 5 Refer- | 1 Refer- | −4.87 | −1.56 | 1 | (Reference) Before forced deterioration, kansui odor is strongly felt, |
| Exam- ple 1 | | | ence | ence | ence | | | | there is texture of soft surface and chewy core, and color is also light |
| | | | | | | | | | yellow. Noodles are browned by forced deterioration, and texture |
| | | | | | | | | | also becomes hard and brittle texture of hard surface and non-sticky |
| | | | | | | | | | core. |
| Com- parative | Tricalcium phosphate | 15 | 4 | 5 | 2 | −4.88 | −3.56 | 3 | Kansui odor before forced deterioration is inferior to that of |
| Exam- ple 2 | | | | | | | | | Comparative Example 1 but is generally good. Texture before forced |
| | | | | | | | | | deterioration is also almost equivalent to that of Comparative Example |
| | | | | | | | | | 1. However, texture after forced deterioration is unacceptable |
| | | | | | | | | | because of bad balance. Discoloration after forced deterioration is |
| | | | | | | | | | suppressed with Comparative Example 1 and is generally acceptable. |
| Com- parative | Calcium monohydrogen | 15 | 4 | 5 | 1 | −4.92 | −3.45 | 3 | Kansui odor before forced deterioration is inferior to that of |
| Exam- ple 3 | phosphate (anhydrous) | | | | | | | | Comparative Example 1 but is generally good. Texture before forced |
| | | | | | | | | | deterioration is also almost equivalent to that of Comparative Example |
| | | | | | | | | | 1. However, texture after forced deterioration is almost unchanged |
| | | | | | | | | | compared with Comparative Example 1. Discoloration after forced |
| | | | | | | | | | deterioration is suppressed with Comparative Example 1 and is |
| | | | | | | | | | generally acceptable. |

As shown by Examples 1 to 4 and Comparative Example 1, discoloration due to forced deterioration was suppressed by adding calcium monohydrogen phosphate hydrate, and therefore, it has been suggested that discoloration is suppressed even when raw Chinese noodles are stored for a long time. Moreover, texture deterioration due to forced deterioration was also suppressed by adding calcium monohydrogen phosphate hydrate, and therefore, it has been suggested that texture deterioration is suppressed even when raw Chinese noodles are stored for a long time. As the amount of the calcium monohydrogen phosphate hydrate added was increased, discoloration due to forced deterioration was more suppressed, but it was found that the kansui odor was weakened and the texture tended to be soft, so that in the case of raw Chinese noodles stored at ordinary temperature, the calcium monohydrogen phosphate hydrate is preferably added in such a manner that the amount thereof added becomes 1 to 2.5% by weight based on the main raw material powder.

As shown by Example 2, Comparative Example 2 and Comparative Example 3, addition of tricalcium phosphate and anhydrous calcium monohydrogen phosphate that belong to the same calcium phosphates resulted in slight suppression of discoloration due to forced deterioration, but the calcium monohydrogen phosphate hydrate had a higher effect of suppressing discoloration due to forced deterioration. Also, regarding the texture deterioration due to forced deterioration, the tricalcium phosphate and the anhydrous calcium monohydrogen phosphate did not have an effect of suppressing texture deterioration, and such an effect proved to be a characteristic effect of the calcium monohydrogen phosphate hydrate.

### <EXPERIMENT 2>STUDIES WITH CHILLED RAW CHINESE NOODLES

### Example 5

With 1 kg of a main raw material powder composed of 1000 g of all-purpose flour, 10 g of an egg white powder, 5 g of gluten, 1.5 g of calcined calcium, and 1.5 g of calcium monohydrogen phosphate hydrate were powder mixed, to the resulting mixture was added. kneading water in which 10 g of salt, 12 g of kansui formulation (sodium carbonate 6:potassium carbonate 4), 50 g of 70% alcohol formulation, 15 g of 60% sodium lactate, 5 g of trehalose, and 1 g of a gardenia pigment were dissolved in 280 g of water, and they were kneaded with a normal pressure mixer for 15 minutes, thereby preparing dough.

The dough prepared was compounded to prepare a noodle belt, the noodle belt was aged for 20 minutes, then the noodle belt was rolled out to 1.5 mm by a rolling method, and the resulting noodle belt was cut with a No. 16 square roll cutting blade, thereby preparing noodle strings.

Subsequently, on 110 g of one serving of the noodle strings prepared, 4 g of flour composed of oxidized starch of sago starch was sprinkled, and the noodle strings were sealed in a polyethylene bag, thereby preparing a raw Chinese noodles sample.

### Example 6

A raw Chinese noodles sample was prepared in accordance with the method of Example 6, except that the amount of the calcium monohydrogen phosphate hydrate added. was changed to 3 g.

### Example 7

A raw Chinese noodles sample was prepared in accordance with the method of Example 6, except that the amount of the calcium monohydrogen phosphate hydrate added. was changed to 5 g.

### Comparative Example 4

A raw Chinese noodles sample was prepared in accordance with the method of Example 5, except that the calcium monohydrogen phosphate hydrate was not added.

The raw Chinese noodles prepared in each experimental plot of Experiment 2 were allowed to stand at 4° C. for 30 days, and they were evaluated by 5 veteran panelists.

The color in each experimental plot after storage was evaluated. Regarding the color, when the chilled raw Chinese noodles were compared with raw Chinese noodles stored at ordinary temperature, such a change as differentiated by a colorimeter was not confirmed, so that only discoloration suppression evaluation by visual observation was carried out. The samples of Comparative Example 4 before and after storage were used as references. A sample that was comparable with Comparative Example 4 before storage was evaluated as very good, a sample that was better than the sample of Comparative Example 4 after storage but was inferior to the sample of Comparative Example 4 before storage was evaluated as good, a sample that was comparable with the sample of Comparative Example 4 after storage was evaluated as fair, and a sample that was worse than the sample of Comparative Example 4 after storage was evaluated as poor.

Regarding sensory evaluation of the test sample, each raw Chinese noodles sample was placed in 1500 ml of boiling water, boiled for 4 minutes, subjected to draining of hot water, and then eaten with soy sauce ramen soup previously prepared, and the evaluation was carried out.

Sensory evaluation of kansui odor was carried out using samples before forced deterioration, and Comparative Example 4 before forced deterioration was used as a reference. A sample that was equivalent to Comparative Example 4 was evaluated as very good, a sample that was slightly inferior to Comparative Example 4 but was good was evaluated as good, a sample that was inferior to Comparative Example 4 was evaluated as fair, and a. sample that was considerably inferior to Comparative Example 4 and had weak kansui odor was evaluated as poor. Regarding the kansui odor, there is almost no difference due to storage deterioration.

Sensory evaluation of a texture was carried out, and the samples of Comparative Example 4 before and after storage were used as references. A sample that was equivalent to Comparative Example 4 before storage was evaluated as very good, a sample that was slightly inferior to Comparative Example 4 before storage but was better than Comparative Example 4 after storage was evaluated as good, a sample that was equivalent to Comparative Example 4 after storage was evaluated as fair, and a sample that was inferior to Comparative Example 4 after storage was evaluated as poor.

The evaluation results of Experiment 2 are set forth in the following Table 2.

TABLE 2

| | Calcium monohydrogen | | | | | |
|---|---|---|---|---|---|---|
| | phosphate (dihydrate) | Color | | Flavor | Texture | |
| Experimental | Amount added (g/kg of main | Before | After | Before | Before | After |
| plot | raw material powder) | storage | storage | storage | storage | storage |
| Example 5 | 1.5 | Very good | Good | Very | Very good | Good |
| | | | | good | | |
| Example 6 | 3.0 | Very good | Very good | Very | Very good | Very |
| | | | | good | | good/good |
| Example 7 | 5.0 | Very good | Very good | Very | Very good | Very |
| | | | | good | | good/good |
| Comparative | 0.0 | Very good, | Fair, | Very | Vety good, | Fair, |
| Example 4 | | Reference | Reference | good, | Reference | Reference |
| | | | | Reference | | |

In the case of the chilled raw Chinese noodles, the noodles were discolored and had a coarse texture by long-term storage though those degrees were not as marked as the raw Chinese noodles stored at ordinary temperature, but as shown by Examples 5 to 7, by adding calcium monohydrogen phosphate (dihydrate), the color tone after storage was improved as compared with the sample without addition. By adding it in an amount of 0.15% by weight or more based on the main raw material powder, obvious improvement in color tone was visually observed. Also, regarding the texture, by adding it in an amount of 0.15% by weight or more based on the main raw material powder, the coarse texture after storage was improved as compared with the sample without addition. In the chilled Chinese noodles, an effect of improving color and texture deterioration during storage was observed even in a small amount, as compared with the raw Chinese noodles stored at ordinary temperature, and moreover, since the amount added was small, flavor deterioration and texture deterioration due to the addition were not observed. It is thought that the amount added may be set to 0.15% by weight or more, and more preferably 0.3% by weight or more, based on the main raw material powder.

1. Raw Chinese noodles comprising calcium monohydrogen phosphate hydrate,

2. The raw Chinese noodles according to claim 1, wherein the calcium monohydrogen phosphate hydrate is contained in an amount of 0.15 to 2.5% by weight based on the weight of a main raw material powder.

3. A method for producing raw Chinese noodles, comprising adding kneading water containing kansui dissolved therein to a powder obtained by adding calcium monohydrogen phosphate hydrate to a main raw material powder and subjecting them to powder mixing, kneading the resulting mixture with a mixer to prepare noodle dough, and then carrying out noodle making.

4. The method for producing raw Chinese noodles according to claim 3, wherein the calcium monohydrogen phosphate hydrate is added in an amount of 0.15 to 2.5% by weight based on the weight of the main raw material powder.

5. A method for suppressing discoloration of raw Chinese noodles, comprising adding calcium monohydrogen phosphate hydrate to noodles.
